(19) United States
(12) Patent Application Publication
(10) Pub. No.: US 2020/0284929 A1
(43) Pub. Date: Sep. 10, 2020

(54) VEHICLE AND ARRANGEMENT OF MICROELECTROMECHANICAL SYSTEMS FOR SIGNAL CONVERSION IN A VEHICLE INTERIOR

(71) Applicant: Ford Global Technologies, LLC, Dearborn, MI (US)

(72) Inventors: Christoph Arndt Dr habil, Moerlen (DE); Frederic Stefan, Aachen (DE); Uwe Gussen, Huertgenwald (DE); Frank Petri, Erftstadt (DE)

(73) Assignee: Ford Global Technologies, LLC, Dearborn, MI (US)

(21) Appl. No.: 16/808,961

(22) Filed: Mar. 4, 2020

(30) Foreign Application Priority Data
Mar. 5, 2019 (DE) 102019202987.6

(51) Int. Cl. G01V 1/00

(52) U.S. Cl. CPC G01V 1/001

(57) ABSTRACT

An arrangement (202) of microelectromechanical systems for signal conversion in a vehicle interior is provided, which has a plurality of microelectromechanical systems (100), which each have at least one signal conversion unit (101) and a communication unit (102). The arrangement (202) furthermore comprises a control device (205) and the plurality of microelectromechanical systems (100) are configured to communicate signals to the control device (202). Provision is made for the plurality of microelectromechanical systems (100) to be arranged in a vehicle interior (201) and for the signals to relate to at least one state parameter of the vehicle interior (201). In addition, a vehicle (200) having a vehicle interior (201), which vehicle has such an arrangement (202), is provided.

### CROSS-REFERENCE TO RELATED APPLICATIONS

The present disclosure claims priority to and the benefit of German patent application No. 102019202987.6, filed Mar. 5, 2019, which is hereby incorporated by reference herein in its entirety.

### FIELD

The present invention relates to an arrangement of microelectromechanical systems for signal conversion in a vehicle interior. In addition, the present invention relates to a vehicle having a vehicle interior, which has such an arrangement.

### BACKGROUND

Vehicles, in particular motor vehicles, for example passenger motor vehicles, heavy goods vehicles and buses, usually have a vehicle interior or a driver cabin whose state can be monitored by way of various sensors and can be influenced by way of various apparatuses. For example, the interior temperature can be measured and changed, music can be output from radio loudspeakers, driver assistance systems can monitor the view of the driver, safety systems can detect the breaking of glass in the event of forced entry etc. Depending on the available sensors, various state parameters of the vehicle interior can be detected for this purpose, for example comfort-related state parameters, for example seat occupancy, an acoustic model of the vehicle interior, the temperature distribution in the vehicle interior or the operating state of the air-conditioning system, but also safety-related state parameters, for example glass breakage detection or the registration of movement in the vehicle interior by detecting acoustic reflections. In addition, state parameters of the vehicle interior that are relevant to the vehicle dynamics can be detected, for example the weight of persons and load capacity in the vehicle interior and also the weight distribution. State parameters of the vehicle interior that are relevant to driving safety can also be detected, for example the size of the occupants for optimum positioning of the seat belts and the headrests.

Normally, all or many of these state parameters are detected by way of very different sensor systems that are suitable for the respective task but not for others. For example, the size of an occupant can be detected by way of an interior camera. However, it is not possible to identify for example an acoustic model of the vehicle interior therewith. In addition, depending on the sensor type used, the possibilities of arranging same in the vehicle interior are limited mostly by way of for example structural restrictions, with the result that the sensitivity thereof is possibly not equally good for each monitored location in the vehicle interior. Moreover, other apparatuses for influencing state parameters of the vehicle interior are often required than to the detection thereof.

### SUMMARY

It is the object of the present invention to provide an improved option by way of which different state parameters of the vehicle interior can at least be detected.

This object is achieved according to the invention by way of an arrangement of microelectromechanical systems for signal conversion in a vehicle interior according to claim 1 and by way of a vehicle according to claim 17. The subclaims specify advantageous refinements of the invention.

In accordance with one aspect of the invention, an arrangement of microelectromechanical systems for signal conversion in a vehicle interior comprises a plurality of microelectromechanical systems (MEMS), which each have at least one signal conversion unit and a communication unit. Moreover, the arrangement comprises a control device, and the plurality of microelectromechanical systems are configured to communicate signals to the control device. Provision is made for the plurality of microelectromechanical systems to be arranged in a vehicle interior and for the signals to relate to at least one state parameter of the vehicle interior.

Microelectromechanical systems (MEMS) are miniaturized apparatuses or assemblies in the low millimeter range or even micrometer range and provide the advantage for example that they are subject to hardly any position restrictions on account of their small size and can be arranged virtually as desired on a surface. Sensors are also available in MEMS structure, for example the ultrasonic sensors described in “Chirp Microsystems Introduces High-Accuracy Touchless Ultrasonic Sensing for Wearables at Mobile World Congress 2017” press release of Feb. 28, 2017 on marketwired.com as runtime sensors or the MEMS described as “smart dust” under “Smart Dust Basics, Components, Applications, Advantages, Disadvantages” (http://www.rfwireless-world.com/Terminology/Smart-dust-components-applications-advantages-disadvantages.html). Capacitive ultrasonic transducers in MEMS structure (CMUT—capacitive micromachined ultrasonic transducers) are also described in principle under “General Description and Advantages of CMUTs” (https://web.archive.org/web/20110720050202/http://www-kyg.stanford.edu/khuriyakub/opencms/en/research/cmuts/general/index.html), Stanford University, archived from original (http://www-kyg.stanford.edu/khuriyakub/opencms/en/research/cmuts/general/index.html) on 20 Jul. 2011.

Such small apparatuses can be arranged at virtually any desired positions in the vehicle interior, even in large amounts, without the normal functionality of the vehicle interior for the occupant or occupants being negatively influenced for example by hindering sight or a lower available space. The arrangement of MEMS is virtually invisible so that it is also not necessary to adapt the design of the vehicle interior.

In this case, the vehicle interior denotes in particular the vehicle cabin, in which the occupants are located. However, in other embodiments, the vehicle interior also comprises other interiors or hollow spaces of the vehicle, for example a trunk, storage space but also an engine compartment, that is to say the space underneath the hood of the motor vehicle.

The signal conversion unit of the microelectromechanical system receives signals from the vehicle interior, for example sound, ultrasound, infrared radiation, radio waves, pressure changes etc. and converts them to electrical signals and/or converts electrical signals to signals that are emitted into the vehicle interior. Signals are communicated by means of the communication unit, which comprises at least one communication interface, for example a wireless communication interface for transmitting and/or receiving electromagnetic waves, laser beams or the like, that is to say depending on the operating mode of the signal conversion unit received signals are transmitted to the control device and/or control signals are received by same.

The control device is an electrical or electronic circuit or programmable apparatus at least having a processor and a memory, configured to actuate the microelectromechanical systems (MEMS) via a separate communication interface directly or indirectly such that said microelectromechanical systems together implement one or more sensor or signal output functionalities. In one particular embodiment, the control device itself is realized by one or more MEMS. For this purpose, in one embodiment, the microelectromechanical systems have separate data processing units or programmable apparatuses, for example separate miniaturized signal processors.

The plurality of microelectromechanical systems can be actuated by the control device as a single array. However, individual portions or subgroups of the plurality of MEMS can also be actuated as separate arrays, by way of which for example different measurements are performed. The use of a plurality of MEMS therefore opens up the opportunity to use same in a variety of ways. The plurality of microelectromechanical systems overall or at least a portion, that is to say a subset, thereof can thus form in particular a multi-sensor array, in which a state variable of the vehicle interior is detected by way of a plurality of MEMS, but depending on the embodiment a plurality of state parameters can also be detected by way of different portions of the plurality of microelectromechanical systems, that is to say of the multi-sensor array, for example different physical variables or else the same measurement variable but in different measurement regions and/or from a plurality of different regions of the vehicle interior.

Depending on the used signal conversion units of the MEMS and also on the number and positioning thereof in the vehicle interior, the entire three-dimensional vehicle interior can also be monitored continuously in order to thus identify and take into account for example changes in the number of occupants, the load distribution or the equipment of the vehicle interior (for example additional seat covers, additional loudspeakers, child seats etc.) in real time.

Owing to the free placement possibility of the MEMS with the signal converters, a quasi-continuous sensor field can be set up and the sensor aperture can be increased, said sensor aperture also being able to be designed so as to be controllable in the case of beam shaping. Such an arrangement can monitor the mass distribution in the vehicle interior for example in a monitoring mode and detect unauthorized entry into the vehicle interior in a theft protection mode. The control device can be designed for example to carry out the evaluation of signals obtained by means of such a sensor array based on methods such as for example principal component analysis (PCA), multiple signal classification (MUSIC), estimation of signal parameters via rotational invariance techniques (ESPRIT) or developments of said methods.

In one embodiment, the microelectromechanical systems (MEMS) in each case do not have a length of more than 3 millimeters in any dimension. Said microelectromechanical systems are preferably even smaller than 1.5 millimeters or even less than 1 millimeter or in the micrometer range. The term “dimension” denotes here the length, width and height, where appropriate also the diameter, of a MEMS.

In one embodiment, the microelectromechanical systems (MEMS) are each configured to communicate at least with one or more adjacent microelectromechanical systems of the plurality of microelectromechanical systems. This includes the control device in some circumstances also not communicating directly with all MEMS at the same time but only with one or a selected subgroup, and the instructions then being communicated further from MEMS to MEMS so that the control device communicates indirectly with most MEMS and direct communication with the control device is prevented as far as possible such that the energy for the required transmission intensity is reduced and the demands on the energy source of the MEMS are reduced. Sensors in this size, in particular when they can communicate as a sensor network with the control device or with one another, are sometimes also referred to as “smart dust”. In one embodiment, at least some of the MEMS used have for this purpose separate data processing units or programmable apparatuses, for example separate miniaturized signal processors.

In one preferred embodiment, at least one cohesive portion of the plurality of microelectromechanical systems (MEMS) is arranged on a common carrier element that can be adjusted in a flexible manner to a region of an inner surface of the vehicle interior. The carrier element may be for example a film or a strip to which the portion of the plurality of microelectromechanical systems is applied, for example adhesively bonded. The carrier element can also itself even be part of the interior trim, for example a seat, door or ceiling cover, a decorative strip or a trim. By virtue of the MEMS being provided on common carrier elements, the handling thereof during arrangement in the vehicle interior is simplified substantially. Strips can thus be fitted for example to the ceiling of the vehicle interior, along interior lighting devices and/or along the vehicle pillars, for example at least along the B and C pillars. This provides the advantage that complete monitoring of the vehicle interior can be made possible in a simple manner.

In one exemplary embodiment, the carrier element is provided with an adhesive coating for adhesive bonding to the region of the inner surface of the vehicle interior. In this way, the MEMS can also be fitted in a very simple manner retrospectively to virtually any desired positions or to locations particularly suitable for the intended use.

In one embodiment, the MEMS each have separate small energy storage units, for example capacitors or batteries, which can be charged for example by means of photoelectric conversion units or photodiodes. In a further embodiment, a common power supply of the microelectromechanical systems of the cohesive portion of the plurality of microelectromechanical systems is provided on the carrier element. In this way, the necessary energy supplied can be realized in an efficient manner. For example, a somewhat larger common battery can be integrated into the carrier element or a connection to a battery provided for the MEMS or the power supply of the vehicle can be provided above the carrier element or hidden below the carrier element.

In one embodiment, the signal conversion units of a first portion of the plurality of microelectromechanical systems are configured to receive reception signals from the vehicle interior and to convert them to electrical signals. Reception signals from the vehicle interior may be for example ultrasonic waves, infrared waves, visible light, acoustic signals or electromagnetic waves, for example radio waves, etc. In order to send the electrical signals or signals derived therefrom to the control device via the communication unit, the electrical signals are where necessary converted, for example to electromagnetic waves or laser signals, depending on how the communication unit is designed. In the described embodiment, the first portion of the plurality of microelectromechanical systems forms a multi-sensor array, by way of which for example ultrasonic waves emitted by transmission units can be received and for example the location of the reflection, for example for object detection, for example the detection of occupants or objects can be identified from the strength of the received signals and the position of the receiving sensors, or other physical variables such as for example the local temperature or moisture can be identified by means of the type of reflection.

In one preferred exemplary embodiment, the signal conversion units of the first portion of the plurality of microelectromechanical systems comprise correlation filters, that is to say “matched filters” or signal-adapted filters, which are designed to filter the electrical signals in order to improve the signal-to-noise ratio (SNR) and therefore to increase the possible resolution of the sensor.

In a further embodiment, the signal conversion units of a second portion of the plurality of microelectromechanical systems are configured to convert electrical signals to output signals and to output them into the vehicle interior. In this way, it is possible to realize for example active sensor systems in which signal conversion units of the second portion of the plurality of microelectromechanical systems output signals, for example ultrasonic signals, whose reflected components are then received by signal conversion units of the first portion of the plurality of microelectromechanical systems. In addition, the state of the vehicle interior can be actively influenced by way of signal conversion units of the second portion of the plurality of microelectromechanical systems. For example, signal conversion units, which are designed to output audio signals, that is to say audible acoustic signals, can thus be provided.

In a further embodiment, the signal conversion units of a third portion of the plurality of microelectromechanical systems are configured to receive reception signals from the vehicle interior and to convert them to electrical signals in a first operating mode and to convert electrical signals to output signals and to output them into the vehicle interior in a second operating mode. Instead of providing different MEMS for the output and the reception of signals, the signal conversion units are designed here to transmit and to receive signals, for example ultrasonic waves. Depending on the embodiment, the switchover between the operating modes is controlled here by the respective microelectromechanical system itself or by control signals from the control device. In particular for the first operating mode in which signals are received from the vehicle interior, in one embodiment provision may be made for filtering of the input signals to be provided for improved reception, in particular by using correlation filters.

In a preferred embodiment, the signal conversion unit of at least one of the plurality of microelectromechanical systems comprises an ultrasonic transducer. Depending on the embodiment, the signal conversion units also of a plurality or all of the plurality of microelectromechanical systems have ultrasonic transducers. An ultrasonic transducer may be for example a piezoelectric and in particular a capacitive microelectromechanical ultrasonic transducer (CMUT—capacitive micromachined ultrasonic transducer). These have a hollow space, a membrane and an electrode and can be produced using conventional production methods for integrated circuits. They are therefore available at a low price and require only little electrical energy for the operation thereof. MEMS having such ultrasonic transducers are able to be positioned at many positions in the vehicle interior in a simple manner. For example, it is possible to use MEMS having such ultrasonic transducers in such a way as to carry out complete ultrasonic monitoring of the vehicle interior.

In a further exemplary embodiment, the signal conversion units of at least the second portion of the plurality of microelectromechanical systems (MEMS) are not ultrasonic transducers. Instead, the signal conversion units of the second portion of the plurality of microelectromechanical systems comprise loudspeaker units, which are designed to output audio signals into the vehicle interior. In this way, due to the arrangement of the MEMS, the sound that is output for the occupants can be improved and the perceptibility of audio signals, which may also be for example acoustic warning signals, can be ensured even at a low volume.

In one exemplary embodiment, the control device is configured to actuate the loudspeaker units based at least on an item of passenger occupancy information such that a sound emitted by the loudspeaker units is improved for passengers in the vehicle interior. In this case, in one embodiment, the item of occupant occupancy information is likewise obtained through the evaluation of signals, which are generated by other MEMS sensors in the vehicle interior, for example ultrasonic sensors. In a further embodiment, not only the positions of the occupants but also additionally the configuration or shape of the interior or other items in the interior, for example luggage and the like, are identified. The loudspeaker units in the MEMS embodiment are used so that the sound distribution in the vehicle interior is optimized dynamically taking into account the current occupant occupancy information and occupancy information regarding other objects.

In a further exemplary embodiment, the control device is configured to actuate the loudspeaker units such that an interference level in the vehicle interior is reduced by way of adapted noise compensation. In this case, in particular the local distribution of the interference level in the vehicle interior is also preferably taken into account. This is identified by way of suitable acoustic MEMS signal conversion units, which are arranged distributed in the vehicle interior and are designed at least also for microphone reception. Owing to the possible high resolution and arrangement of the loudspeaker units covering preferably the entire vehicle interior, the interference compensation can be optimized for a plurality of locations in the vehicle interior, for example for head positions of the occupants.

In one embodiment, the control device is configured to actuate the signal conversion units of the plurality of microelectromechanical systems in such a way that at least one selected portion of the signal conversion units interacts as beam shaper. Depending on the embodiment, a transmission beam shaping or a reception beam shaping or both can be provided. In this way, for example when ultrasonic conversion units are used, orientations and limitations of objects and occupants in the vehicle interior can be determined highly precisely in a simple manner so that for example an item of occupant occupancy information or size information regarding occupants, objects in the vehicle interior or particular forms of the vehicle interior or the orientation of the head or the viewing direction of the driver can be identified even more exactly. While reception beam shaping serves to detect the “transmitting source” (for example breaking glass window) or the location of the reflection, transmission beam shaping (in combination with one or more receivers) can be used for example to monitor selected regions in the vehicle interior (for example seat locations of the occupants).

In one exemplary embodiment, the control device is configured to dynamically change an orientation of a beam shaping of the beam shaper, or to change said orientation over time. In this way, it is possible for example to realize a space monitoring beam, which moves about, for example rotates in a circular manner, in the vehicle interior so that changes of position of occupants and objects in the vehicle interior can be detected precisely and promptly.

In accordance with a further aspect of the invention, a vehicle having a vehicle interior is provided, comprising an arrangement of microelectromechanical systems for signal conversion in a vehicle interior according to one of the embodiments described above. In this way, the advantages and particular features of the arrangement of microelectromechanical systems for signal conversion in a vehicle interior according to the invention are also implemented within the context of a vehicle having such an arrangement.

Further advantages of the present invention will emerge from the more detailed description and from the figures. The invention is described in more detail below in connection with the following description of exemplary embodiments with reference to the accompanying figures, in which:

### BRIEF DESCRIPTION OF THE DRAWINGS

FIG. 1 shows a schematic illustration of an example of a possible structure of a microelectromechanical system for signal conversion in a vehicle interior;

FIG. 2 shows a schematic illustration of a vehicle having a vehicle interior, which vehicle has an arrangement of microelectromechanical systems for signal conversion in a vehicle interior according to the invention in an exemplary design; and

FIG. 3 shows a schematic illustration of a vehicle interior, which has an arrangement of microelectromechanical systems for signal conversion in a vehicle interior according to the invention in a further exemplary design.

### DETAILED DESCRIPTION

It is self-evident that other embodiments may be utilized, and structural or logical modifications performed, without departing from the scope of protection of the present invention. It is self-evident that the features of the various exemplary embodiments described above and below may be combined with one another unless specifically stated otherwise. The description therefore must not be viewed as being of a limiting nature, and the scope of protection of the present invention is defined by the appended claims.

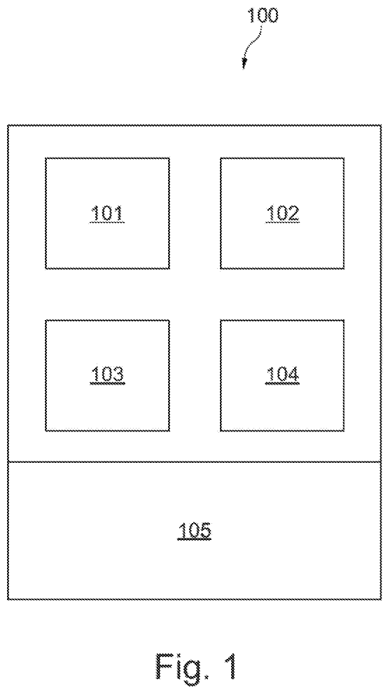

FIG. 1 shows a schematic illustration of an example of a possible structure of a microelectromechanical system for signal conversion in a vehicle interior. The microelectromechanical system 100 is no greater than 3 millimeters in any dimension and has a signal conversion unit 101, by way of which electrical signals are converted to output signals. In the example shown, the signal conversion unit 101 is a capacitive ultrasonic transducer, which in a first operating mode converts electrical signals to ultrasonic signals and in a second operating mode converts received ultrasonic signals to electrical signals.

The microelectromechanical system 100 shown also has a communication unit 102, by means of which control signals and received sensor signals can be communicated either to adjacent further microelectromechanical systems or directly to a control device. The communication unit 102 is designed for wireless communication by means of electromagnetic waves or laser light signals.

The microelectromechanical system 100 shown also has a data processing unit 103, for example a signal processor, whereby, in addition to the control of the transmission and reception modes, inter alia a signal filter is implemented, by way of which electrical signals from the conversion of incoming reception signals from the signal conversion unit can be subjected to correlation filtering. In another embodiment, the correlation filtering is realized directly as part of the signal conversion unit.

In addition, the microelectromechanical system shown has a separate power supply: A photoelectric conversion unit 104 is configured to convert incident light to electrical energy and to store it in a power storage unit 105 in the form of a battery or a capacitor. The signal conversion unit 101, the communication unit 102 and the data processing unit 103 are supplied with said electrical energy.

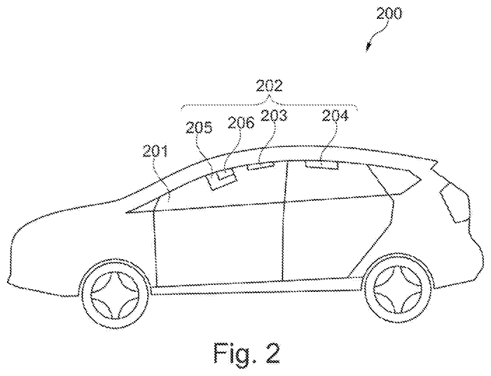

FIG. 2 shows a schematic illustration of a vehicle 200 having a vehicle interior 201 in an exemplary design, said vehicle having an arrangement 202 of microelectromechanical systems for signal conversion in a vehicle interior. The arrangement 202 of microelectromechanical systems for signal conversion in a vehicle interior consists on the one hand of a plurality of microelectromechanical systems (MEMS), as are shown for example in FIG. 1. The MEMS, which each have at least one signal conversion unit and a communication unit, are not shown individually in FIG. 2. The plurality of MEMS are introduced into the vehicle interior on carrier elements. A first portion of the plurality of microelectromechanical systems 203 is attached to the ceiling of the vehicle interior 201 in the region of the driver position. A second portion of the plurality of microelectromechanical systems 204 is attached to the ceiling of the vehicle interior 201 in the region of a passenger (not shown) on the back seat. Further portions of the plurality of microelectrical systems are arranged in the vehicle interior but are not shown in FIG. 2. On the other hand, the arrangement 202 of microelectromechanical systems for signal conversion in a vehicle interior comprises a control device 205. In this embodiment, the control device 205 itself is not a microelectromechanical system. However, in other embodiments, provision may be made for the control device 205 to also be provided as a MEMS. The control device 205 has a programmable apparatus (not shown) having a processor and a memory. When it is executed by the processor, the program code stored in the memory causes the control device 205 to communicate signals to at least one of the microelectromechanical systems, for example the first portion of the plurality of microelectromechanical systems 203, via a communication interface 206, wherein the transmissions from and to the control device 205 then take place for the MEMS that do not directly communicate with the control device by way of forwarding the communication signals between adjacent MEMS via the communication units thereof. The plurality of microelectromechanical systems is therefore configured to communicate signals to the control device 205 either directly or indirectly by means of other MEMS.

In the example shown, the signal conversion units of the MEMS arranged in the vehicle interior are capacitive ultrasonic transducers (CMUTs), wherein ultrasonic waves are emitted by way of ultrasonic transducers in transmission mode, said ultrasonic waves being reflected in the vehicle interior 201 by the inner surface thereof but also by occupants and other objects (not shown) and being received by ultrasonic transducers in a reception mode. The received signals thus relate to the surface and objects in the vehicle interior 201 and therefore state parameters of the vehicle interior 201. The received ultrasonic signals are converted to electrical signals by the signal conversion units and are evaluated or filtered by signal processors of the MEMS. The individual reception signals evaluated are then transmitted to the control device 205 for evaluation of the signals of the entire array of MEMS by way of signal conversion units in reception mode to the control device 205.

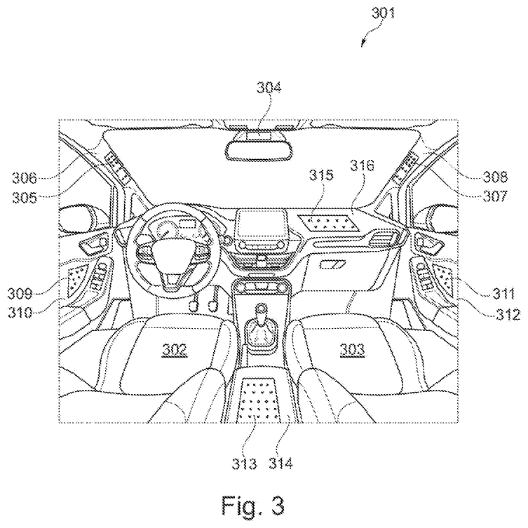

FIG. 3 shows a schematic illustration of a vehicle interior 301, which has an arrangement of microelectromechanical systems for signal conversion in a vehicle interior according to the invention, in an exemplary design. The vehicle interior 301 of a vehicle shown in a partial view from inside has a vehicle seat 302 and a passenger seat 303, wherein the arrangement of microelectromechanical systems for signal conversion in a vehicle interior is designed, in particular, to detect (in particular position determinations) and to change (in particular sound improvement by way of interference compensation and optimized audio outputs in the vehicle interior based on the position of the occupants) state parameters of the vehicle interior 301 taking into account the positions of the driver and the passenger, for example through emission and reflected reception of ultrasonic signals and audio signals.

In the exemplary embodiment shown, the arrangement of microelectromechanical systems for signal conversion in a vehicle interior that is fitted in the vehicle interior comprises, in addition to a control device 304 having at least one communication interface (not shown), a plurality of microelectromechanical systems. In the example shown, different portions of said plurality of microelectromechanical systems are applied to different surfaces in the vehicle interior 301 on carrier elements in the form of strips having an adhesive coating. A first strip having a portion of the plurality of microelectromechanical systems 305 is fitted to the left A pillar 306, a second strip having a further portion of the plurality of microelectromechanical systems 307 is fitted to the right A pillar 308, a third strip having a further portion of the plurality of microelectromechanical systems 309 is fitted to the driver door panel 310, a fourth strip having a further portion of the plurality of microelectromechanical systems 311 is fitted to the passenger door panel 312, a fifth strip having a further portion of the plurality of microelectromechanical systems 313 is fitted to an armrest 314 between the driver seat 302 and the passenger seat 303, and a sixth strip having a further portion of the plurality of microelectromechanical systems 315 is fitted to the dashboard 316. Further and/or alternative positions for strips having further portions of the plurality of microelectromechanical systems are possible.

The figures are not necessarily accurate in all details and true to scale, and may be presented on an enlarged scale or a reduced scale in order to provide a better overview. Therefore, functional details disclosed here are to be understood not as being of a limiting nature but rather merely as an illustrative basis that provides a person skilled in the art in this technological field with guidance for using the present invention in a versatile manner.

The expression “and/or” used here, where used in a series of two or more elements, means that each of the stated elements may be used individually, or any combination of two or more of the stated elements may be used. For example, if a configuration is described in such a way that it comprises the components A, B and/or C, the configuration may comprise A on its own; B on its own; C on its own; A and B in combination; A and C in combination; B and C in combination; or A, B and C in combination.

Although the invention has been illustrated and described in more detail on the basis of the preferred exemplary embodiments, the invention is not restricted by the disclosed examples, and other variations may be derived therefrom by a person skilled in the art without departing from the scope of protection of the invention. The invention is therefore not intended to be limited to individual embodiments, but rather only by the appended claims.

### LIST OF REFERENCE DESIGNATIONS

100 Microelectromechanical system

101 Signal conversion unit

102 Communication unit

103 Data processing unit

104 Photoelectric conversion unit

105 Power storage unit

200 Vehicle

201 Vehicle interior

202 Arrangement of microelectromechanical systems

203 First portion of the plurality of microelectromechanical systems

204 Second portion of the plurality of microelectromechanical systems

205 Control device

206 Communication interface

301 Vehicle interior

302 Driver seat

303 Passenger seat

304 Control device

305 First strip having a portion of the plurality of MEMS

306 Left A pillar

307 Second strip having a further portion of the plurality of MEMS

308 Right A pillar

309 Third strip having a further portion of the plurality of MEMS

310 Driver door panel

311 Fourth strip having a further portion of the plurality of MEMS

312 Passenger door panel

313 Fifth strip having a further portion of the plurality of MEMS

314 Armrest

315 Sixth strip having a further portion of the plurality of MEMS

316 Dashboard

That which is claimed is:

1. A system for signal conversion in a vehicle interior, the system comprising:
a plurality of microelectromechanical systems (100), which each have at least one signal conversion unit (101) and a communication unit (102); and
a control device (205),
wherein the plurality of microelectromechanical systems are configured to communicate signals to the control device (205), and
wherein the plurality of microelectromechanical systems are arranged in the vehicle interior (201) and the signals relate to at least one state parameter of the vehicle interior (201).

2. The system according to claim 1, wherein the plurality of microelectromechanical systems (100) each do not have a length of more than 3 millimeters in any dimension.

3. The system according to claim 1, wherein the plurality of microelectromechanical systems (100) are each configured to communicate with one or more adjacent microelectromechanical systems of the plurality of microelectromechanical systems.

4. The system according to claim 1, wherein at least one cohesive portion of the plurality of microelectromechanical systems (203) is arranged on a common carrier element that is configured to be adjusted in a flexible manner to a region of an inner surface of the vehicle interior (201).

5. The system according to claim 4, wherein the common carrier element is provided with an adhesive coating for adhesive bonding to the region of the inner surface of the vehicle interior (201).

6. The system according to claim 4, wherein a common power supply of microelectromechanical systems of the cohesive portion of the plurality of microelectromechanical systems is provided on the common carrier element.

7. The system according to claim 1, wherein the at least one signal conversion unit (101) of a first portion of the plurality of microelectromechanical systems is configured to receive reception signals from the vehicle interior (201) and to convert them to electrical signals.

8. The system according to claim 7, wherein the at least one signal conversion unit (101) of the first portion of the plurality of microelectromechanical systems (203) comprises correlation filters, which are configured to filter the electrical signals.

9. The system according to claim 1, wherein the at least one signal conversion unit (101) of a second portion of the plurality of microelectromechanical systems (204) is configured to convert electrical signals to output signals and to output them into the vehicle interior (201).

10. The system according to claim 1, wherein the at least one signal conversion unit of a third portion of the plurality of microelectromechanical systems is configured in a first operating mode to receive reception signals from the vehicle interior (201) and to convert them to electrical signals and in a second operating mode to convert electrical signals to output signals and to output them into the vehicle interior (201).

11. The system according to claim 1, wherein the at least one signal conversion unit (101) of one of the plurality of microelectromechanical systems comprises an ultrasonic transducer.

12. The system according to claim 9, wherein the at least one signal conversion unit (101) of the second portion of the plurality of microelectromechanical systems (204) comprise loudspeaker units, which are designed to output audio signals into the vehicle interior.

13. The system according to claim 12, wherein the control device (205) is configured to actuate the loudspeaker units based at least on an item of occupant occupancy information such that a sound emitted by the loudspeaker units is improved for passengers in the vehicle interior (201).

14. The system according to claim 12, wherein the control device (205) is configured to actuate the loudspeaker units such that an interference level in the vehicle interior (201) is reduced by way of adapted noise compensation.

15. The system according to claim 1, wherein the control device (205) is configured to actuate the at least one signal conversion unit (101) of the plurality of microelectromechanical systems in such a way that at least one selected portion of the at least one signal conversion unit (101) interacts as a beam shaper.

16. The system according to claim 15, wherein the control device (205) is configured to dynamically change an orientation of a beam shaping of the beam shaper.

17. A vehicle (200) having a vehicle interior (201), the vehicle comprising:
a plurality of microelectromechanical systems (100), which each have at least one signal conversion unit (101) and a communication unit (102); and
a control device (205),
wherein the plurality of microelectromechanical systems are configured to communicate signals to the control device (205), and
wherein the plurality of microelectromechanical systems are arranged in the vehicle interior (201) and the signals relate to at least one state parameter of the vehicle interior (201).
